(19) United States
(12) Patent Application Publication
(10) Pub. No.: US 2007/0275273 A1
(43) Pub. Date: Nov. 29, 2007

(54) Trimetaspheres for Ion Selective Membranes

(75) Inventors: Bryan Koene, Blacksburg, VA (US); J. Paige Phillips, Hattlesburg, MS (US); Martin E. Rogers, Blacksburg, VA (US)

Correspondence Address: BUCHANAN, INGERSOLL & ROONEY PC, POST OFFICE BOX 1404, ALEXANDRIA, VA, 22313-1404, US

(73) Assignee: LUNA INNOVATIONS INCORPORATED, Roanoke, VA (US)

(21) Appl. No.: 10/594,028

(22) PCT Filed: Mar. 25, 2005
(86) PCT No.: PCT/US05/10215

§ 371 Date: Jul. 23, 2007

Related U.S. Application Data
(60) Provisional application No. 60/556,433, filed on Mar. 26, 2004.

(51) Int. Cl. H01M 8/10

(52) U.S. Cl. 429/13; 429/33

(57) ABSTRACT

An ion selective membrane is provided where the membrane has improved ionic conductivity and mobility at elevated temperatures. The ion selective membrane includes a metallofullerene, where the metallofullerene may be a trimetasphere. The metallofullerene is incorporated into membrane materials that can withstand elevated temperatures, where the metallofullerene improves ionic conductivity and mobility therein.

### BACKGROUND

The present invention is directed towards improving operational capabilities of ion conductive membranes. This includes improvements in, but not limited to, ionic mobility, ionic conductivity, thermal stability, chemical stability, dimensional stability, etc, using metallofullerenes in ion conductive membranes.

One use of ion conductive membranes is as a membrane in a fuel cell. In general, fuel cells operate similar to batteries, but do not run down or require recharging. A fuel cell is an electrochemical energy conversion device that produces electric power by combining hydrogen and oxygen to form water. This combination occurs by combining a fuel and an oxidant to electricity and a reaction product.

Fuel cells, as illustrated in FIG. 1, generally include a membrane 300 and two electrodes, called a cathode 200 and an anode 100, where the membrane 300 is sandwiched between the cathode 200 and anode 100. Operationally, a fuel, which may be hydrogen, is fed to the anode 100, while an oxidant, which may be oxygen (or air), is fed to the cathode 200.

At the anode 100, hydrogen is separated into hydrogen ions (protons) and electrons, where the protons and electrons take different paths to the cathode 200. The protons migrate from the anode 100 through the membrane 300 to the cathode 200, while the electrons migrate from the anode 100 to the cathode 200 through an external circuit 400 in the form of electricity. The oxidant, which is supplied to the cathode 200, reacts with the hydrogen ions that have crossed the membrane 300 and with the electrons from the external circuit 400 to form liquid water as the reaction product. Thus, the fuel cell generates electricity and water through an electrochemical reaction.

Membranes used in the fuel cells must allow ionic mobility and conductivity therethrough and are usually semi-permeable membranes, such as for example U.S. Pat. No. 5,928,807, which is incorporated herein. These membranes may be used to separate an anode compartment and a cathode compartment of the fuel cell from one another, but are primarily designed to enable the transport of protons from the anode to the cathode.

One type of membrane used in fuel cells is a Proton Exchange Membrane (PEM). PEM fuel cells operate at relatively low temperatures (about 175° F. or 80° C.), can vary their output quickly to meet shifts in power demand and have relatively high power density compared to other fuel cell technologies.

A PEM can be made of a variety of material, such as one or more polymers and/or copolymers and/or polymer blends. In general, a PEM is a thin plastic sheet that allows hydrogen ions to pass through it, thus conducting only positively charged ions and blocking electrons. The membrane may be coated on both sides with metal particles, such as catalysts, where the catalyst facilitates the reaction of oxygen and hydrogen by splitting hydrogen into hydrogen ions and electrons, and splitting oxygen gas into two oxygen atoms. After the splittings, the negative charge of oxygen atoms attracts the positively charge of hydrogen ions through the PEM, where the hydrogen ions combine with the oxygen atoms and electrons from the external circuit to form a water molecule.

PEMs in general have demonstrated excellent proton conductivity required for fuel cells below 80° C. However, recent advances in fuel cell research require their use at high temperatures (above 120° C., preferably up to 160° C.) to supplement catalytic capacity and improved operation, and these PEMs are generally less stable at high temperatures. For example, when these PEMs are exposed to temperatures up to 120° C., discolorations in the membrane may occur and may signal the start of an irreversible change in the material.

As a result, other polymers have been developed for use in membranes at higher temperature. Polymers such as polysulphone (PSU), polyether sulphone (PES), polyether etherketone (PEEK), polyimide (PI), cellulose acetate (CA), polyacrylonitrile (PAN), and polybenzimidazole (PBI) may be used as the membrane in a PEM fuel cell that is operated at more than 120° C. See U.S. Pat. Nos. 5,525,436 and 6,706,435, which are incorporated herein.

Additionally, approaches have been developed for increasing the proton conductivity at higher temperatures. For example, the use of inorganic materials such as zirconium phosphonates has demonstrated improvements in the area, as have sulfonated versions of thermally stable polymers such as polysulfone, polyimides, poly(arylene ether), etc., as well as incorporating fullerene derivatives having proton-dissociating groups into proton conducting material. For example, see U.S. Pat. No. 6,635,377 B2, where a fullerenol is used and active proton conducting characteristics are achieved due to dissociation of H⁺ from a phenolic hydroxyl group of a fullerene of molecule.

However, despite their effectiveness in improving the thermal stability, the proton (and other ion) mobility and conductivity of these materials is relatively low compared with the state of the art membranes used at ambient conditions. As such, improvement of the ionic mobility and conductivity at elevated temperatures is needed.

### SUMMARY

One object of the present invention is to improve ionic conductivity for an ion conducting membrane at elevated temperatures. More specifically, an object of the present invention is to provide a membrane, which includes a membrane material and a metallofullerene in said membrane material. Through the inclusion of a metallofullerene in a membrane, the ionic conductivity of an ion conducting membrane can be altered.

Another object is to provide a fuel cell, which includes a cathode, an anode, a membrane between the cathode and the anode, and a metallofullerene in said membrane.

Another object is to provide a method of using a membrane in a fuel cell including placing a membrane in the fuel cell, wherein said membrane comprise a membrane material and a metallofullerene, and elevating a temperature of said fuel cell to above about 100° C., wherein said metallofullerene increases ionic conductivity and thermal stability of the membrane above about 100° C.

### BRIEF DESCRIPTION OF THE DRAWINGS

FIG. 1 illustrates a fuel cell.

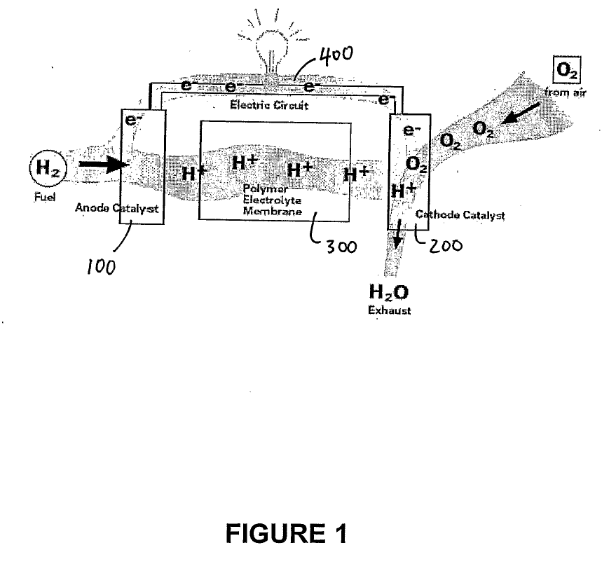

FIG. 2 is an illustration of a trimetasphere according to an embodiment.

FIG. 3 is an illustration of a calculated charge distribution in a trimetasphere.

### DETAILED DESCRIPTION

In order to improve ionic mobility and conductivity of a material, specifically a membrane, even more specifically an ion conductive membrane, at elevated temperatures, metallofullerenes may be incorporated therein. Preferably, trimetaspheres, which have unique chemistries that improve the ionic mobility and conductivity of a material at elevated temperatures when incorporated into the material, are provided.

Trimetaspheres have two distinct advantages over other materials, including other fullerenes, because of their structure. The first advantage is increased thermal, chemical and dimensional stability. The second advantage is increased ionic mobility and conductivity.

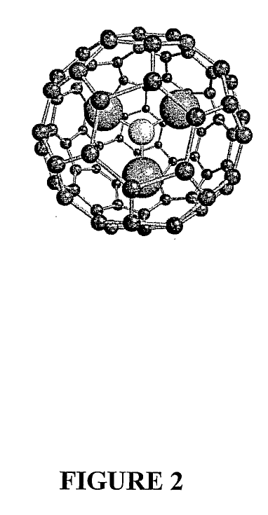

First, due to the closed shell electronic structure of the encapsulated metal-nitrogen complex of a trimetasphere, as illustrated in FIG. 2, high thermal, chemical and dimensional stability is provided by the trimetasphere. This increase in stability, in turn, leads to an increased stability compared with other materials including classical fullerenes and metallofullerenes.

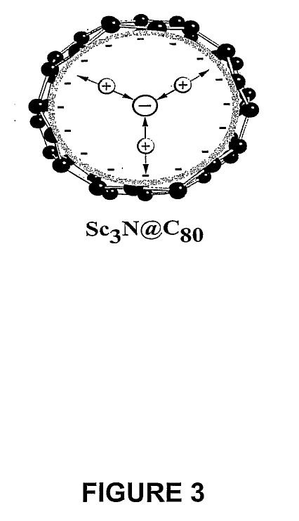

Second, again because of the closed shell electronic structure of the encapsulated metal-nitrogen complex of a trimetasphere, a charge distribution is developed, as illustrated in FIGS. 3 and 4. This charge distribution allows for increased ionic mobility and conductivity compared with other materials, where the encapsulated metal atoms confer novel electronic properties resulting in superior ion and electron accepting (ease of reduction) and transferring (high mobility) properties.

In addition to the increase in ionic mobility and conductivity created by the encapsulated metal-nitrogen complex, trimetaspheres may also have improved ionic mobility and conductivity because trimetaspheres are more polar (polarizable) than other carbonaceous nanomaterials. The polarizability can be provided if at least two different metal atoms are encapsulated in the trimetasphere. For example, two, three or four different metals can be incorporated into a trimetasphere, where each metal type and location will inherently cause a polarity in the trimetasphere due to the charge of each metal type. Because of this increased polarizability, the trimetaspheres may enjoy an increased solubility in more polar solvents and increased retention times on separation media that discriminates according to polarizability and compound polarity. As a result, unanticipated advantages may be realized in system compatibility and miscibility with cell components, in place of less polar classical fullerenes.

Trimetaspheres are preferable to classical metallofullerenes because the trimetaspheres offer more stability, higher yields and no risk of bonding metal atoms unlike classical metallofullerenes. Further discussion of trimetaspheres including methods of manufacturing trimetaspheres can be found in U.S. Pat. No. 6,303,750, which is hereby incorporated by reference.

FIG. 3 illustrates a representation of a trimetasphere in which A¹, A², and A³ are the same or different atoms, and N is nitrogen. Trimetaspheres may have compositions which include metal atoms from group III or rare earth elements. For example, the metal atoms may be Sc, Y, La, Ce, Pr, Nd, Gd, Dy, Ho, Er, and/or Tm. Differing electronic properties are expected for variations not yet discovered having alternative structures with different atoms from the periodic table.

Preferred embodiment ion conductive membranes may use trimetasphere materials as a membrane on their own, or incorporated into a host such as an inorganic or organic material, a polymer, or combination of these. For example, trimetasphere materials can be used to form a membrane on their own by using a binder to hold the trimetasphere materials. Or, if the trimetasphere materials are incorporated into a host, as mentioned above, inorganic materials such as zirconium phosphonates, as well as organic materials and polymers, such as polysulfone, polyimides, poly(arylene ether), etc., may be used.

Additionally, if the trimetasphere materials are incorporated into a host, a host capable of use in elevated temperatures higher than 80° C. is preferable, as the trimetasphere materials have thermal stability well in excess of 300° C. Therefore, an upper limit of the temperature stability of membranes with trimetaspheres therein is limited primarily by the host material and not the trimetaspheres. As such, host materials (and thus the membranes) should be thermally stable at temperatures preferably above 160° C. or even more preferably temperatures at or above 200° C. For example, if trimetaspheres are incorporated into a polyimide host with a thermal stability up to about 300° C., the membrane should likewise have thermal stability up to about 300° C.

In a preferred embodiment, a membrane including trimetaspheres can be incorporated into a fuel cell and used as a PEM. In this embodiment, fuel cell is most preferably operated at a permanent service temperature of at least 120° C. As such, the host material of the membrane is preferably a thermoplastic polymer, where the membrane has a permanent service temperature of at least 120° C. Therefore, by using a membrane including trimetaspheres, the fuel cell can be operated at elevated temperatures, while the conductivity of protons through the PEM may be increased by the presence of trimetaspheres.

In another preferred embodiment of the present invention, a trimetasphere may be provided in a membrane, where the trimetasphere may include portions derivatized on an outer portion of the carbon fullerene cages with organic or inorganic group or groups. These organic or inorganic groups may be added to further improve the ionic properties of the trimetaspheres in a host matrix. For example, the addition of these groups may further improve the ionic mobility, solubility and conductivity through a membrane with trimetaspheres. A more preferred embodiment would involve the derivatization of the trimetasphere with individual or mixtures of the following groups: hydroxyl (—OH), sulfate (—SO₃H), sulfonate (—OSO₃H), carboxylic acid (—CO₂H), or phosphonic acid (—OPO(OH)₃) groups.

One exemplary method of making a membrane including a metallofullerene includes dissolving a membrane host material, such as a polymer, and a metallofullerene in a solvent, forming a membrane film on a substrate, heating and drying the membrane film to form a membrane, then removing the membrane from the substrate

For example, in a preferred embodiment, the membrane base material may include an acidified sulfonated polymer such as sulfonated polysulfone. This membrane base material may then be dissolved in a dimethylacetamide or other organic solvent. Preferably, such dissolution would provide about a 5-10% transparent solution. Next, this solution may be filtered through a filter, preferably a 0.2 micron Teflon filter. Next, metallofullerene components, or more preferably trimetaspheres components, may also be dissolved into the solution. Next, the solution may be cast onto clean glass substrates to form a membrane film. The membrane film can then be heated, preferably under nitrogen to about 60° C. using any heating device, preferably an oven or an infrared lamp in order to form a membrane. The membrane can then be vacuum-dried, preferably for about 36 hours, increasing the temperature to a final temperature, preferably about 150° C., to remove the solvent, resulting in a free-standing membrane film.

Possible uses for the application are those in which membranes with high ionic mobility are required. These include, but are not limited to, using these membranes in fuel cells (hydrogen, methanol, or other), lithium ion batteries, photovoltaics, etc.

The preferred embodiments are merely illustrative and should not be considered restrictive in any way. The scope of the invention is given by the appended claims, rather than the preceding description, and all variations and equivalents which fall within the range of the claims are intended to be embraced therein.

1. An ion conductive membrane, comprising:
a membrane material; and
a metallofullerene in said membrane material.

2. The membrane of claim 1, wherein said metallofullerene increases the ionic conductivity of the membrane at elevated temperatures.

3. The membrane of claim 1, wherein said metallofullerene comprises a trimetasphere.

4. The membrane of claim 3, wherein said trimetasphere includes portions derivatized on an outer portion of the carbon fullerene cages with organic or inorganic group or groups.

5. The membrane of claim 1, wherein said metallofullerene comprises nitrogen.

6. The membrane of claim 1, wherein said metallofullerene comprises a rare earth element.

7. The membrane of claim 1, wherein said metallofullerene comprises a group III element.

8. The membrane of claim 1, wherein said metallofullerene comprises Sc, Y, La, Ce, Pr, Nd, Gd, Dy, Ho, Er, and/or Tm.

9. The membrane of claim 1, wherein said membrane material comprises polysulphone (PSU), polyether sulphone (PES), cellulose acetate (CA), polyacrylonitrile (PAN), polyether etherketone (PEEK), polyimide (PI), and/or polybenzimidazole (PBI).

10. The membrane of claim 1, wherein membrane comprises an ion conductive membrane.

11. A fuel cell, comprising:
a cathode;
an anode;
an ion conductive membrane between the cathode and the anode; and
a metallofullerene in said membrane.

12. The fuel cell of claim 11, wherein said metallofullerene increases the ionic conductivity and mobility of the membrane at elevated temperatures.

13. The fuel cell of claim 11, wherein said metallofullerene comprises a trimetasphere.

14. The fuel cell of claim 13, wherein said trimetasphere includes portions derivatized on an outer portion of the carbon fullerene cages with organic or inorganic group or groups.

15. The fuel cell of claim 11, wherein said metallofullerene comprises nitrogen.

16. The fuel cell of claim 11, wherein metallofullerene comprises a rare earth element.

17. The fuel cell of claim 11, wherein said metallofullerene comprises a group III element.

18. The fuel cell of claim 11, wherein said metallofullerene comprises Sc, Y, La, Ce, Pr, Nd, Gd, Dy, Ho, Er, and/or Tm.

19. The fuel cell of claim 11, Wherein said membrane material comprises polysulphone (PSU), polyether sulphone (PES), cellulose acetate (CA), polyacrylonitrile (PAN), polyether etherketone (PEEK), polyimide (PI), and/or polybenzimidazole (PBI).

20. The fuel cell of claim 11, wherein membrane material comprises an ion conductive membrane.

21. A method of using an ion conductive membrane in a fuel cell, comprising:
placing an ion conductive membrane in the fuel cell, wherein said membrane comprise a membrane material and a metallofullerene; and
elevating a temperature of said fuel cell to above about 100° C., wherein said metallofullerene increases ionic conductivity and mobility and thermal stability of the membrane above about 100° C.

22. The method of claim 21, wherein said metallofullerene comprises a trimetasphere.
